(19) United States
(12) Patent Application Publication
(10) Pub. No.: US 2014/0034235 A1
(43) Pub. Date: Feb. 6, 2014

(54) METHOD FOR PRODUCING OPTICAL ELECTRICAL FIELD ENHANCING DEVICE

(71) Applicant: FUJIFILM CORPORATION, Tokyo (JP)

(72) Inventors: Shogo YAMAZOE, Ashigarakami-gun (JP); Masayuki NAYA, Ashigarakami-gun (JP)

(73) Assignee: FUJIFILM CORPORATION, Tokyo (JP)

(21) Appl. No.: 14/041,877

(22) Filed: Sep. 30, 2013

Related U.S. Application Data
(63) Continuation of application No. PCT/JP2012/002072, filed on Mar. 26, 2012.

(30) Foreign Application Priority Data
Mar. 31, 2011 (JP) 2011-077868

(51) Int. Cl. G01J 3/44

(52) U.S. Cl. CPC G01J 3/44
USPC 156/322; 427/124

(57) ABSTRACT

A thin film of a first metal or a metal oxide is formed on a substrate. A structure layer of fine protrusions and recesses of the first metal or a hydroxide of the metal oxide is formed by causing the thin film formed on the substrate to undergo a hydrothermal reaction. Thereafter, a metal structure layer of fine protrusions and recesses is formed on the surface of the structure layer of fine protrusions and recesses.

### TECHNICAL FIELD

The present invention is related to a method for producing an optical electrical field enhancing device equipped with a metal structure of fine protrusions and recesses capable of inducing localized Plasmon.

### BACKGROUND ART

Sensor devices that utilize the electrical field enhancing effect due to localized plasmon on the surfaces of metals and electrical field enhancing devices of Raman spectroscopic devices are known. Raman spectroscopy is a technique that obtains the spectrum of Raman scattered light (Raman spectrum) by spectrally analyzing scattered light obtained by irradiating a substance with a single wavelength light beam, and is utilized to identify substances.

There is a Raman spectroscopy technique called SERS (Surface Enhanced Raman Scattering) that utilizes an optical electrical field enhanced by localized plasmon resonance in order to amplify weak Raman scattered light (refer to S. Ghadarghadr et al., “Plasmonic array nanoantennas on layered substrates: modeling and radiation characteristics”, OPTICS EXPRESS, Vol. 17, No. 21, pp. 18556-18570, 2009). SERS utilizes the principle that when light is irradiated onto a metal body, particularly a metal body having nano order protrusions and recesses on the surface thereof, while the metal body is in contact with a substance, optical electrical field enhancement occurs due to localized plasmon resonance, and the intensity of Raman scattered light of a sample in contact with the surface of the metal body is amplified. Surface enhanced Raman scattering can be executed by employing a substrate having a metal structure of protrusions and recesses on the surface thereof as a carrier (substrate) that holds test subjects.

Si substrates, on the surface of which protrusions and recesses are provided, having metal films formed on the surface having the protrusions and recesses, are mainly employed as substrates having metal structures of protrusions and recesses on the surfaces thereof (refer to POT Japanese Phase Publication No. 2006-514286, Japanese Patent No. 4347801, and Japanese Unexamined Patent Publication No. 2006-145230).

In addition, an Al substrate, the surface of which is anodized such that a portion thereof becomes a metal oxide layer (Al₂O₃) and a plurality of fine pores which are formed naturally within the metal oxide layer during the anodizing process are filled with metal, has also been proposed (refer to U.S. Pat. No. 7,288,419).

### DISCLOSURE OF THE INVENTION

The metal structure of fine protrusions and recesses producing method is complex and it is difficult to form metal structures of fine protrusions and recesses having large areas in the inventions of PCT Japanese Phase Publication No. 2006-514286, Japanese Patent No. 4347801, and Japanese Unexamined Patent Publication No. 2006-145230 that employ photolithography and etching to form the structures of fine protrusions and recesses and the invention of U.S. Pat. No. 7,288,419 that employs anodic oxidation to form the structures of fine protrusions and recesses. Therefore, it is considered that the cost of substrates per unit area is high. In addition, it is extremely difficult to form the aforementioned metal structures of fine protrusions and recesses on complex substrates such as liquid containers constituted by a plurality of protrusions and recesses.

The present invention has been developed in view of the foregoing circumstances. It is an object of the present invention to provide method for producing an optical electrical field enhancing device on substrates having arbitrary shapes, over comparatively large areas, and at low cost.

A method for producing an optical electrical field enhancing device of the present invention comprises:

a thin film forming step that farms a thin film formed of one of a first metal and a metal oxide on a substrate;

a structure layer of fine protrusions and recesses forming step that forms a structure layer of fine protrusions and recesses formed of one of the first metal and the metal oxide, by causing the thin film formed on the substrate to undergo a hydrothermal reaction; and

a metal layer forming step that forms a metal structure layer of fine protrusions and recesses constituted by a second metal on the surface of the structure layer of fine protrusions and recesses.

It is preferable for a metal layer having a structure of protrusions and recesses having a different shape from the structure layer of fine protrusions and recesses on the surface thereof to be formed as the metal structure layer of fine protrusions and recesses in the metal layer forming step.

The second metal is preferably one of gold, silver, copper, aluminum, and platinum, or an alloy having one of these metals as a main component. Au and Ag are particularly preferable.

The metal layer forming step may be a metal vapor deposition step that forms the metal layer constituted by the second metal on the surface of the structure layer of fine protrusions and recesses by vapor deposition.

In the case that the second metal is gold, it is desirable for the thickness of the film formed by vapor deposition to be 30 nm or greater.

In the case that the second metal is silver, it is desirable for the thickness of the film formed by vapor deposition to be 150 nm or less.

The method for producing an optical electrical field enhancing device of the present invention may further comprise:

a laminating step that laminates one of a third metal different from the second metal and a dielectric on the metal structure layer of fine protrusions and recesses formed by the second metal.

In the method for producing an optical electrical field enhancing device of the present invention, the metal film forming step may be a fine metal particle dispersing step that disperses fine metal particles formed by the second metal on the surface of the structure layer of fine protrusions and recesses.

It is preferable for the diameters of the fine metal particles to be 100 nm or less.

The first metal may be aluminum, and the metal oxide may be alumina.

It is desirable for the hydroxide to be at least one of bayerite and boehmite.

The method for producing an optical electrical field enhancing device of the present invention enables obtainment of an optical electrical field enhancing device with a metal structure layer of fine protrusions and recesses having sizes on the order of several tens of nanometers by the simple steps of: the thin film forming step that forms a thin film formed of one of a first metal and a metal oxide on a substrate; the structure layer of fine protrusions and recesses forming step that forms a structure layer of fine protrusions and recesses formed of one of the first metal and the metal oxide, by causing the thin film formed on the substrate to undergo a hydrothermal reaction; and the metal layer forming step that forms the metal structure layer of fine protrusions and recesses constituted by a second metal on the surface of the structure layer of fine protrusions and recesses.

Because an optical electrical field enhancing device can be obtained by these extremely simple steps, manufacturing costs can be greatly reduced compared to those of conventional devices.

In addition, each of the steps can be applied to substrates having comparatively large areas and substrates having arbitrary shapes. Therefore, it is possible to produce optical electrical field enhancing devices having large areas and optical electrical field enhancing devices having desired shapes.

An optical electrical field enhancing device obtained by the production method of the present invention is capable of effectively inducing localized plasmon at the surface of the metal structure of fine protrusions and recesses when light is irradiated onto the fine metal protrusions and recesses on the surface thereof. The localized plasmon generates an optical electrical field enhancing effect. In addition, light generated by a test subject placed on the optical electrical field enhancing device when light is irradiated onto the region at which the test subject is placed will be amplified by the optical electrical field enhancing effect, and it becomes possible to detect the generated light at high sensitivity. The optical electrical field enhancing device can be favorably employed as a surface enhanced Raman substrate that effectively amplifies Raman signals, to achieve improvements in detection sensitivity.

### BRIEF DESCRIPTION OF THE DRAWINGS

FIG. 1 is a collection of sectional diagrams that illustrate the steps of a method for producing an optical electrical field enhancing substrate.

FIG. 2A is a perspective view of an electrical field enhancing substrate 1, which is a first embodiment of the optical electrical field enhancing device of the present invention.

FIG. 2B is a magnified view of a portion IIB of a lower portion of the side surface of the optical electrical field enhancing substrate 1 illustrated in FIG. 2A.

FIG. 3 is a SEM image of the surface of a boehmite layer.

FIG. 4A is a SEM image of the surface of a (30 nm thick) vapor deposited gold layer.

FIG. 4B is a SEM image of the surface of a (60 nm thick) vapor deposited gold layer.

FIG. 4C is a SEM image of the surface of a (90 nm thick) vapor deposited gold layer.

FIG. 4D is a SEM image of the surface of a (150 nm thick) vapor deposited gold layer.

FIG. 4E is a SEM image of the surface of a (250 nm thick) vapor deposited gold layer.

FIG. 4F is a SEM image of the surface of a (400 nm thick) vapor deposited gold layer.

FIG. 5A is a SEM image of the surface of a (30 nm thick) vapor deposited silver layer.

FIG. 5B is a SEM image of the surface of a (60 nm thick) vapor deposited silver layer.

FIG. 5C is a SEM image of the surface of a (90 nm thick) vapor deposited silver layer.

FIG. 5D is a SEM image of the surface of a (150 nm thick) vapor deposited silver layer.

FIG. 5E is a SEM image of the surface of a (250 nm thick) vapor deposited silver layer.

FIG. 5F is a SEM image of the surface of a (400 nm thick) vapor deposited silver layer.

FIG. 6 is a graph that illustrates a Raman spectrum distribution obtained for a sample having a vapor deposited gold film (60 nm thick).

FIG. 7 is a graph that illustrates a Raman spectrum distribution obtained for a sample having a vapor deposited silver film (60 nm thick).

FIG. 8 is a graph that illustrates the film thickness dependent properties of Raman signal intensities obtained for samples having vapor deposited gold films.

FIG. 9 is a graph that illustrates the film thickness dependent properties of Raman signal intensities obtained for samples having vapor deposited silver films.

### BEST MODE FOR CARRYING OUT THE INVENTION

Hereinafter, an embodiment of a method for producing an optical electrical field enhancing device of the present invention will be described with reference to the attached drawings.

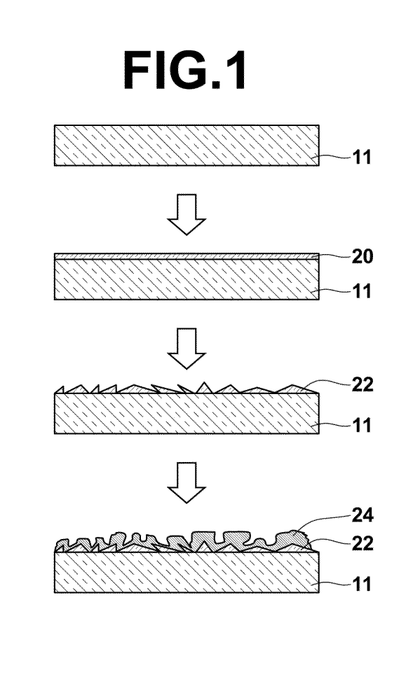

FIG. 1 illustrates a method for producing an optical electrical field enhancing substrate, which is an embodiment an optical electrical field enhancing device, and is a collection of sectional diagrams that illustrate each step of the method.

A plank shaped transparent substrate main body 11 is prepared. The transparent substrate main body 11 is cleansed with acetone and methanol. Thereafter, aluminum is employed as a first metal, and an aluminum film 20 is formed on the surface of the transparent substrate main body 11 at a thickness of approximately several tens of nanometers by the sputtering method as a thin film forming step.

Next, the transparent substrate main body 11 having the aluminum film 20 thereon is immersed in boiling pure water then taken out after several minutes (approximately 5 minutes) as a structure layer of fine protrusions and recesses forming step. The boiling treatment (hydrothermal reaction) renders the aluminum film 20 transparent, and produces a transparent structure layer of fine protrusions and recesses 22 formed by bayerite or boehmite.

Next, a second metal is vapor deposited onto the structure layer of fine protrusions and recesses 22, as a metal layer forming step.

A plank shaped substrate was employed in the example described above. However, the steps of the method may be applied to substrates of any desired shape.

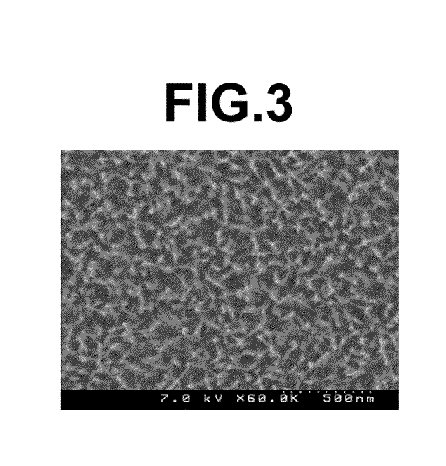

Aluminum is an example of the first metal that undergoes the hydrothermal reaction in the structure layer of fine protrusions and recesses forming step. Alternatively, a metal oxide such as alumina (Al(OH)₃) may be employed. A structure of fine protrusions and recesses having complex triangular pyramid structures (refer to FIG. 3) formed of either or both of bayerite (Al[OH]₃) and boehmite (AlOOH) can be formed, by aluminum or alumina undergoing the hydrothermal reaction.

As alternatives to aluminum, metals that form structures of fine protrusions and recesses by undergoing hydrothermal reactions, such as titanium (Ti), may be employed as the first metal.

In addition, the method for forming the film of the first metal or the metal oxide onto the substrate 11 is not limited to the sputtering method. The film may alternatively be formed by the heated vapor deposition method or by the sol gel method.

The hydrothermal reaction is not limited to the boiling process. As an alternative process, the substrate on which the film of the first metal has been formed may be exposed to high temperature steam, to cause the first metal to react with the high temperature steam.

The second metal that constitutes the metal structure layer of fine protrusions and recesses 24 may be any metal that generates localized plasmon when irradiated with excitation light. Examples of such metals include: gold (Au), silver (Ag), copper (Cu), aluminum (Al), platinum (Pt), and alloys having these metals as their main components. Au and Ag are particularly preferable.

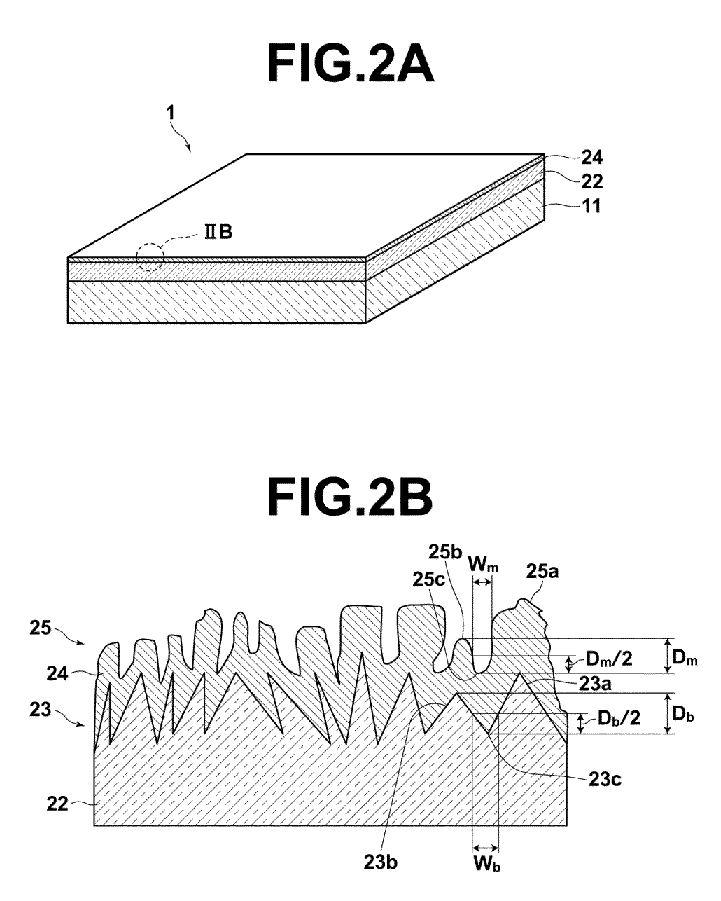

FIG. 2A is a perspective view that illustrates the optical electrical field enhancing substrate 1. FIG. 2B is a magnified view of a portion IIB of the side surface of the optical electrical field enhancing substrate 1 illustrated in FIG. 2A.

As illustrated in FIG. 2A and FIG. 2B, the optical electrical field enhancing substrate 1 is constituted by the substrate 11, the structure layer of fine protrusions and recesses 22 having the structure of fine protrusions and recesses 23 on the surface thereof provided on the substrate 11, and the metal structure layer of fine protrusions and recesses 24 (metal layer) formed on the surface of the structure of fine protrusions and recesses 23. Localized plasmon resonance is induced by light (hereinafter, excitation light) irradiated onto a structure of fine protrusions and recesses 25 of the metal structure layer of fine protrusions and recesses 24, and an enhanced optical electrical field is generated on the surface of the metal structure layer of fine protrusions and recesses 24 by the localized plasmon resonance.

The transparent structure of fine protrusions and recesses 23 formed by the metal hydroxide or a hydroxide of a metal oxide such as boehmite has an overall saw toothed cross section, although the sizes (the sizes of the peak angles) and orientations of the protrusions vary. The transparent structure of fine protrusions and recesses 23 is that on which the metal structure layer of fine protrusions and recesses 24 can be formed, and has an average pitch and an average depth which are less than the wavelength of the excitation light. Note that here, the pitch of the transparent structure of fine protrusions and recesses 23 is the distance among the peaks of adjacent protrusions having recesses therebetween, and the depth is the distance from the peaks of the protrusions to the bottoms of the recesses adjacent thereto.

Note that in the case that a transparent substrate such as a glass substrate is employed as the substrate 11, and a transparent structure layer of fine protrusions and recesses 22 formed by a bayerite layer or a boehmite layer is formed, excitation light can be caused to enter from either the front surface or the back surface of the substrate to generate the optical electrical enhancing field at the surface of the metal layer 24. In addition, signal light such as Raman signal light can also be detected from either the front surface or the back surface of the substrate. Here, the term transparent refers to a transmissivity of 50% or greater with respect to irradiated light and with respect to light generated by a test subject due to the irradiated light. Note that it is more preferable for the transmissivity with respect to these types of light to be 75% or greater, and even more preferably, 90% or greater.

The metal structure layer of fine protrusions and recesses 24 is formed along the surface of the structure layer of fine protrusions and recesses 22, and may have substantially the same structure of fine protrusions and recesses as the structure of fine protrusions and recesses 23. Alternatively, the structure of fine protrusions and recesses 25 of the metal structure layer of fine protrusions and recesses 24 may have protrusions and recesses of shapes different from the structure of fine protrusions and recesses 23 of the structure layer of fine protrusions and recesses 22, as illustrated in FIG. 2B.

If the thickness of vapor deposited metal is thin in the production method described above, the structure of fine protrusions and recesses of the metal layer will have substantially the same structure of fine protrusions and recesses as the structure of fine protrusions and recesses 23 of the structure layer of fine protrusions and recesses 22. If the thickness of vapor deposited metal is thick, the metal structure layer of fine protrusions and recesses 24 will have a structure of fine protrusions and recesses in which the distances among adjacent protrusions is less than the distances among corresponding protrusions of the structure of fine protrusions and recesses 23, as illustrated in FIG. 2B. Protrusions 24a of the metal structure layer of fine protrusions and recesses 24 are rounded, and the distances among adjacent protrusions are smaller compared to a case in which a metal film is formed along the structure of fine protrusions and recesses 23 of the structure layer of fine protrusions and recesses 22.

It is preferable for portions at which the distance Wm between a protrusion 25a and an adjacent protrusion 25b in the structure of fine protrusions and recesses 25 of the metal structure layer of fine protrusions and recesses 24 is less than the distance Wb between a protrusion 23a and a protrusion 23b of the structure of fine protrusions and recesses 23 of the substrate corresponding to the protrusions 25a and 25b to be present, as illustrated in FIG. 2B. Here, the distance Wm between the adjacent protrusions 25a and 25b is defined as the distance from the peak of the lower protrusion 25b to a position of the protrusion 25a having half the depth Dm/2 of the depth Dm of the deepest portion of a recess 25c between the adjacent protrusions 25a and 25b. Similarly, the distance Wb between the adjacent protrusions 23a and 23b is defined as the distance from the peak of the lower protrusion 23b to a position of the protrusion 23a having half the depth Db/2 of the depth Db of the deepest portion of a recess 23c between the adjacent protrusions 23a and 23b.

The structure of fine protrusions and recesses 25 of the metal structure layer of fine protrusions and recesses 24 is a structure of fine protrusions and recesses in which at least one of the length of the protrusions in the direction perpendicular to the substrate and the length of the protrusions in the direction parallel to the substrate is less than the wavelength of excitation light, such that localized plasmon can be generated on the surface of the metal structure layer of fine protrusions and recesses 24.

It is desirable for the protrusions of the metal structure layer of fine protrusions and recesses 24 to be granules formed by agglomeration of metal. It is desirable for the aspect ratio (length in the direction perpendicular to the substrate/length in the direction parallel to the substrate) of the granular protrusions to be 0.5 or greater.

Note that it is desirable for the average depth from the peaks of the protrusions to the bottoms of recesses adjacent thereto to be 200 nm or less, and for the average pitch among the peaks of adjacent protrusions having recesses therebetween to be 200 nm or less in the structure of fine protrusions and recesses 25 of the metal structure layer of fine protrusions and recesses 24.

In the case that the metal structure layer of fine protrusions and recesses is formed on the structure of fine protrusions and recesses of the substrate by vapor deposition, it is preferable for the thickness to be 400 nm or less in the case that gold is used as the metal and for the thickness to be 90 nm or less in the case that silver is used as the metal. A metal structure of fine protrusions and recesses capable of generating an efficiently enhanced optical electrical field can be obtained, by vapor depositing amounts of gold or silver corresponding to these thicknesses.

Note that it is not necessary for the distances among all adjacent protrusions in the structure of fine protrusions and recesses of the metal structure layer of fine protrusions and recesses to be less than the distances among corresponding adjacent protrusions in the structure of fine protrusions and recesses of the substrate. However, the optical electrical field enhancing effect will become more significant as the number of adjacent protrusions of the metal structure layer of fine protrusions and recesses having distances less than the distances of corresponding adjacent protrusions in the structure of fine protrusions and recesses of the substrate increases.

Particularly, if there are regions at which the distances among adjacent protrusions of the metal structure layer of fine protrusions and recesses 25 are 20 nm or less, extremely intense optical electrical field enhancing fields, called hot spots, can be generated at such regions. For this reason, it is preferable for a great number of locations at which the distance between adjacent protrusions is 20 nm or less to be present.

In the above embodiment, only a single layer of the second metal is employed. Alternatively, two or more types of metal can be laminated. Further, a dielectric may be laminated onto the second metal. Interference effects and oxidization preventing effects can be imparted by laminating two or more types of metals or by laminating a dielectric on the second metal. That is, Light will be trapped within the structure layer if the thickness of the structure layer matches a certain phase of the light by the optical interference effect, and a more intense optical electrical field enhancing effect can be generated. In addition, the oxidization of silver can be suppressed by providing a silver layer as the second metal, and the by laminating gold on the silver layer.

Note that in the case that a dielectric is to be laminated on the metal structure layer of fine protrusions and recesses formed by the second metal, it is desirable for the thickness of the dielectric to be 50 nm or less. SiO₂ may be laminated at a thickness of 10 nm on the metal structure layer of fine protrusions and recesses, for example.

The above embodiment was described as a case in which the vapor deposition method is employed as the method for forming the metal structure of fine protrusions and recesses. Alternatively, the metal structure layer of fine protrusions and recesses may be formed by dispersing and arranging fine particles of the second metal on the surface of the structure layer of fine protrusions and recesses.

It is preferable for the diameters of the fine particles of the second metal to be 100 nm or less, from the viewpoint of obtaining high optical electrical field enhancing effects.

The following are examples of methods for dispersing and immobilizing fine metal particles onto the structure layer of fine protrusions and recesses.
1) dispersing fine metal particles in an organic solvent, casting a colloidal solution onto a boehmite substrate, then drying;
2) adsorbing a polycationic or a cationic molecular film onto a boehmite substrate, the dispersing and immobilizing fine metal particles on the film by electrostatic interactions;
3) modifying a boehmite substrate with a thiol derivative, and immobilizing fine metal particles onto the boehmite substrate utilizing spontaneous bonds formed between metal and sulfur; and
4) agglomerating fine metal particles on a boehmite substrate by the electrophoresis method, utilizing the fact that the fine metal particles are negatively charged.

The metal structure of fine protrusions and recesses, in which fine metal particles are dispersed and immobilized on the structure layer of fine protrusions and recesses can be obtained by methods such as those described above.

### EXAMPLES

Hereinafter, concrete production examples of the optical electrical field enhancing substrate 1, which is an embodiment of the optical electrical field enhancing device of the present invention, and the results of Raman spectrum measurement employing measurement samples, will be described.

### [Method for Producing Optical Electrical Field Enhancing Substrate]

A glass substrate (BK-7: Eagle 2000 by Corning) was employed as the transparent substrate main body 11.

The glass substrate main body 11 underwent ultrasonic cleansing (45 kHz) with acetone for 5 minutes and with methanol for 5 minutes. Then, a 25 nm thick layer of aluminum 20 was formed on the glass substrate 11 using a sputtering apparatus (by Canon Anelva). Note that a surface shape measuring device (by TENCOR) was employed to measure the thickness of the aluminum layer, and the thickness was confirmed to be 25 nm (±100).

Thereafter, pure water was prepared in a water bath (by Nishi Seiki K. K.) and boiled. The glass substrate main body 11 having the aluminum layer 20 thereon was immersed in the boiling water, then removed after 5 minutes had passed. At this time, it was confirmed that the aluminum became transparent 1 to 2 minutes after the glass substrate 11 having the aluminum layer 20 thereon was immersed in the boiling water. This is because the aluminum layer 20 became the structure layer of fine protrusions and recesses 22 formed by boehmite or bayerite by the boiling treatment.

FIG. 3 illustrates the results of observing the surface of the boehmite layer 22 with a SEM (S4100 by Hitachi). The white portions of FIG. 3 are protrusions, and the gray portions are recesses. The patterns of protrusions and recesses are irregular, but are formed across the entirety of the surfaces of the boehmite layer, and the in plane uniformity of the structure of fine protrusions and recesses is high. It can be understood that the structure of protrusions and recesses is constituted by a great number of peak shaped protrusions from the photograph of the surface of the boehmite layer illustrated in FIG. 3. Note that the cross section of the structure of protrusions and recesses of the boehmite layer is saw toothed as schematically illustrated in FIG. 2B.

Finally, 30 nm worth of Au was vapor deposited onto the surface of the boehmite layer 22 by EB (Electric Beam) vapor deposition, to produce a sample with a metal structure layer of fine protrusions and recesses 24. Note that samples in which 60 nm, 90 nm, 150 nm, 250 nm, and 400 nm worth of Au were deposited on the surface of the transparent structure layer of fine protrusions and recesses 22, as well as samples in which 60 nm, 90 nm, 150 nm, 250 nm, and 400 nm worth of Ag were deposited on the surface of the transparent structure layer of fine protrusions and recesses 22, were also produced. Here, the vapor deposited film thickness is measured by preparing glass substrates for measuring thickness separately from the samples, masking a portion of the surface of each glass substrate for measuring thickness, performing vapor deposition by placing the glass substrates for measuring thickness in a vapor deposition chamber with the substrates of the samples, removing the tape from the glass substrates for measuring thickness following vapor deposition, then measuring the thickness from surfaces where the tape is peeled off, on which metal has not been vapor deposited, to the surface of the vapor deposited metal.

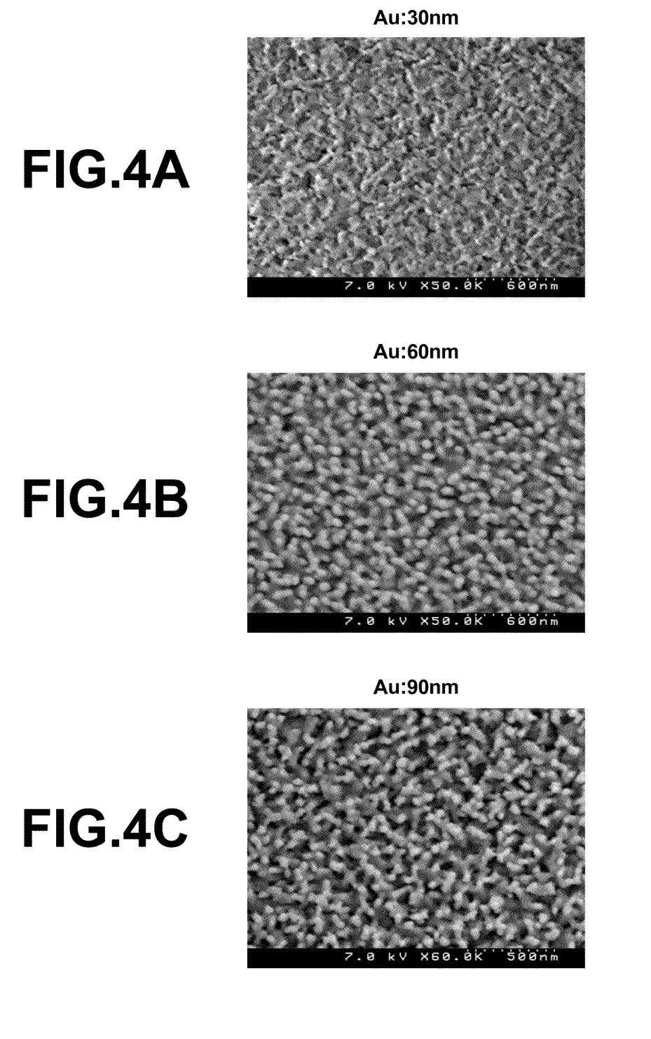

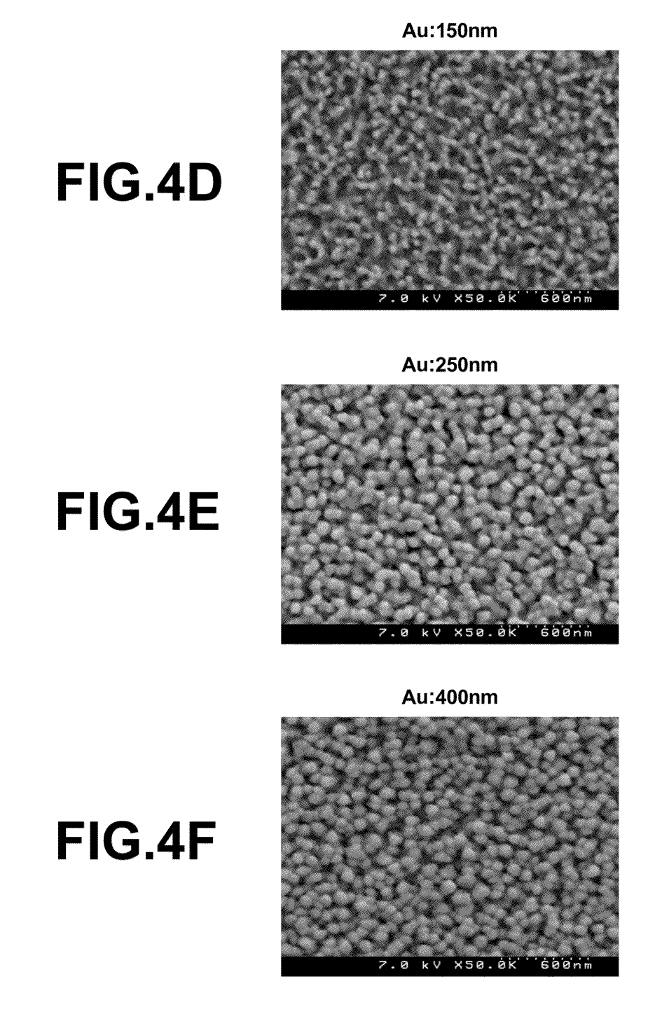

SEM images of the surface of each sample on which Au was vapor deposited are illustrated in FIGS. 4A through 4F, and SEM images of the surface of each sample on which Ag was vapor deposited are illustrated in FIGS. 5A through 5F.

In the case of Au vapor deposition, as the thickness of the gold formed by vapor deposition increases, the protrusions agglomerate and become granulated to form granular metal structures of fine protrusions and recesses having shapes different from that of the structure of fine protrusions and recesses 25 on the surface of the bayerite or boehmite, as illustrated in FIGS. 4A through 4F. When light is irradiated onto these metal granular shapes, extremely intense optical electrical fields called “hot spots” are generated among the granules, which is preferable in optical electrical field enhancing substrates. The granules become larger as the film thickness becomes thicker. As can be seen in FIG. 4F, the granular shapes are maintained even at a film thickness of 400 nm.

In the case of Ag vapor deposition, as the thickness of the silver formed by vapor deposition increases, the silver gradually at thicknesses from 30 nm through 90 nm to from island structures as illustrated in FIGS. 5A through 5C, and it is considered that the silver film layer gradually becomes flat. As illustrated in FIGS. 5D through 5F, the silver forms larger granular structures within thicknesses from 150 nm through 400 nm.

### (Measurement of Raman Scattered Light)

100 μl of an ethanol solution in which rhodamine 6G was dissolved was spotted onto each sample of the optical electrical field enhancing substrate produced by the method described above. The solution was allowed to dry, and the dried samples were employed to measure Raman scattered light.

Raman scattered light was detected employing a microscopic Raman spectroscope (HR800). A laser beam having a peak wavelength of 785 nm was employed as the excitation light beam, and observation was performed at a magnification of 20×. The laser power was 0.5 mW immediately after an objective lens, and the irradiation time was 10 seconds.

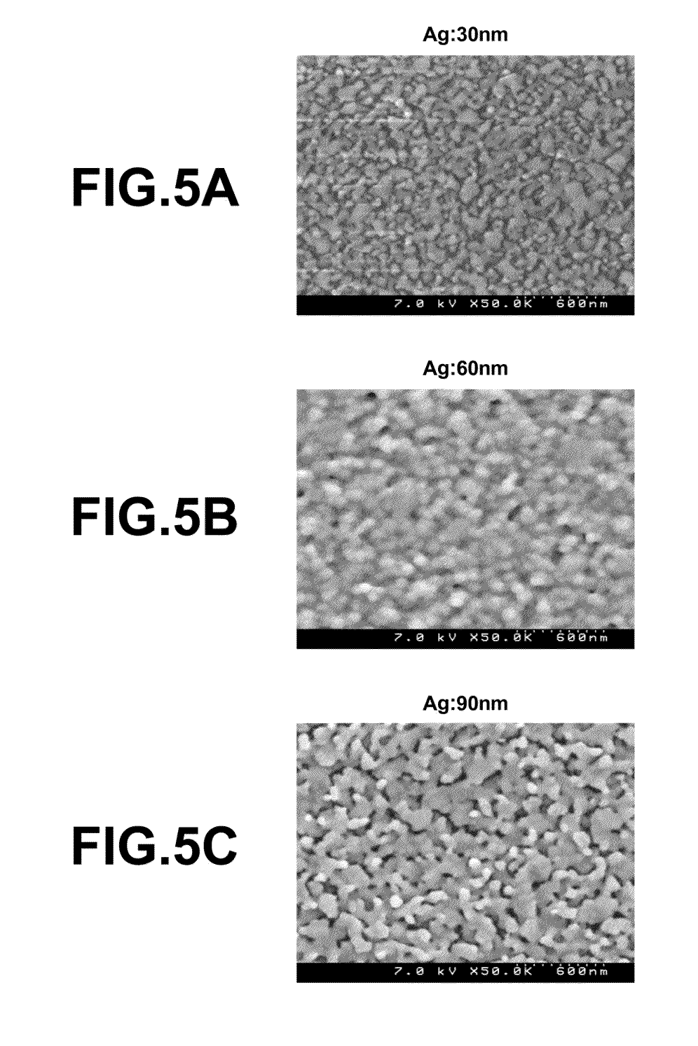

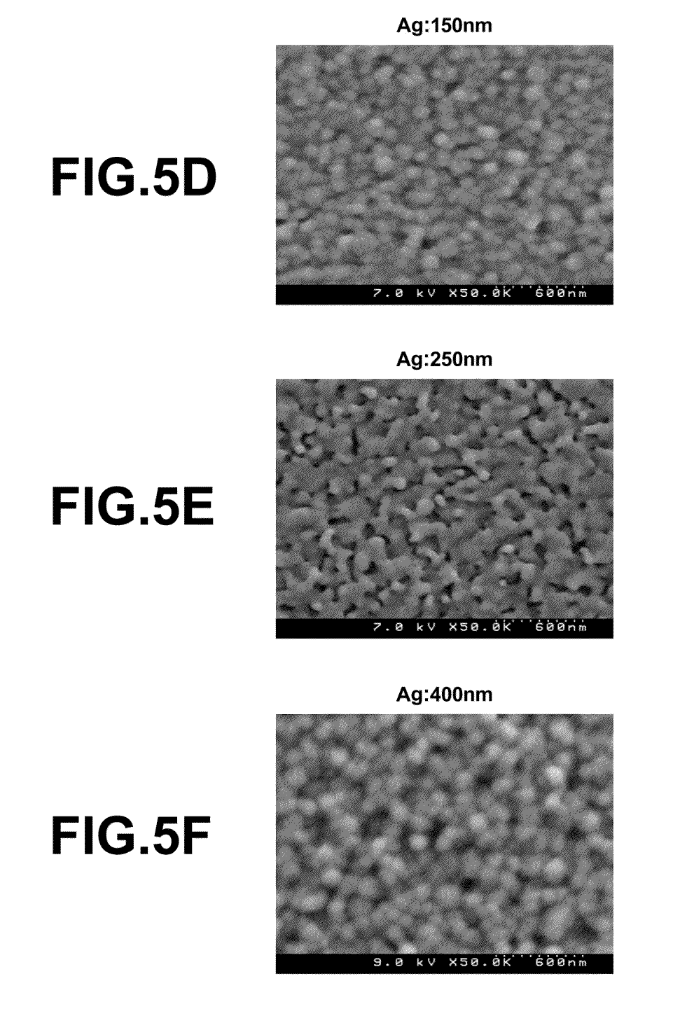

FIG. 6 and FIG. 7 are graphs that illustrate Raman shift spectrum distributions detected by the microscopic Raman spectroscope. FIG. 6 illustrates the Raman spectrum obtained for a sample onto which 60 μm of Au was vapor deposited, and FIG. 7 illustrates the Raman spectrum obtained for a sample onto which 60 μm of Ag was vapor deposited.

The samples produced by the method for producing an optical electrical field enhancing substrate of the present invention, for which the Raman spectrum distributions are illustrated in FIGS. 6 and 7, enabled obtainment of extremely intense Raman signals. Note that more intense Raman signals were obtained from samples having thinner vapor deposited film thicknesses (30 nm and 60 nm) when silver was employed as the second metal compared to cases in which gold was employed as the second metal.

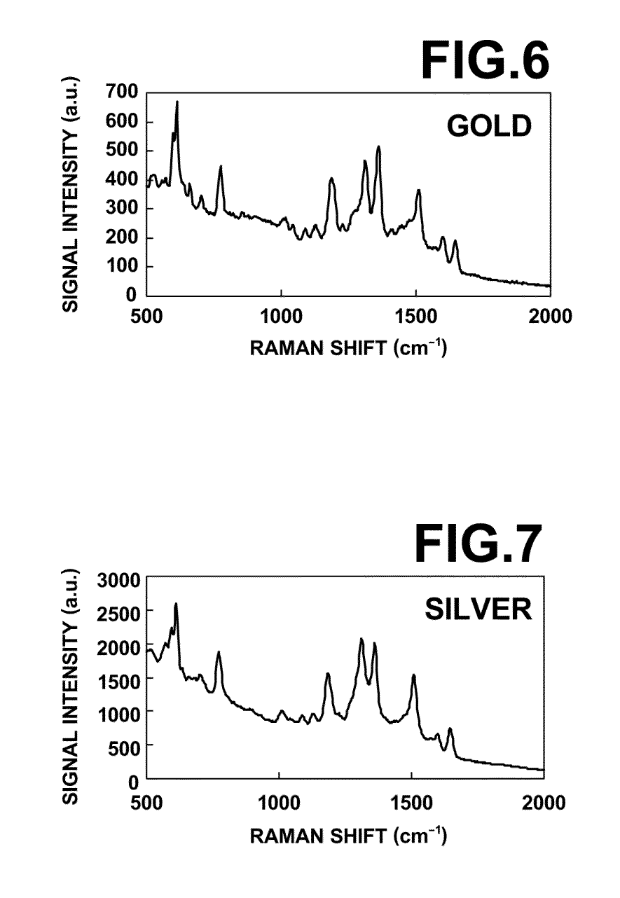

FIG. 8 is a graph that plots peak intensities of 1360 cm⁻¹ after removing white noise against Au vapor deposited film thickness as the horizontal axis, using Raman shift spectrum distributions obtained by detecting Raman scattered light at the front surfaces of the substrates for each of the samples on which Au was vapor deposited.

As illustrated in FIG. 8, greater signal intensities were obtained as the Au vapor deposited film thickness became greater within a range of gold film thicknesses from 30 nm through 90 nm. As the vapor deposited film thickness of Au becomes thicker, Au forms granular shapes and the distances among protrusions become smaller to form a great number of hot spots as is clear from the SEM images of FIG. 4A through FIG. 4C. These are considered to be the reasons for the increase in signal intensity. Meanwhile, as illustrated in FIG. 8, at gold film thicknesses from 150 nm through 400 nm, signal intensities are lower than those obtained at gold film thicknesses from 30 nm through 90 nm. The reason for the decrease in signal intensities is considered to be because the degree of optical electrical field enhancement deteriorates because the granule sizes increase, the granules contact each other, and become electrically continuous with each other. The signal intensity is greatest at the film thickness of 90 nm. However, sufficient optical electrical enhancing effects are obtained at film thicknesses from 150 nm through 400 nm, and amplified Raman signals are detected.

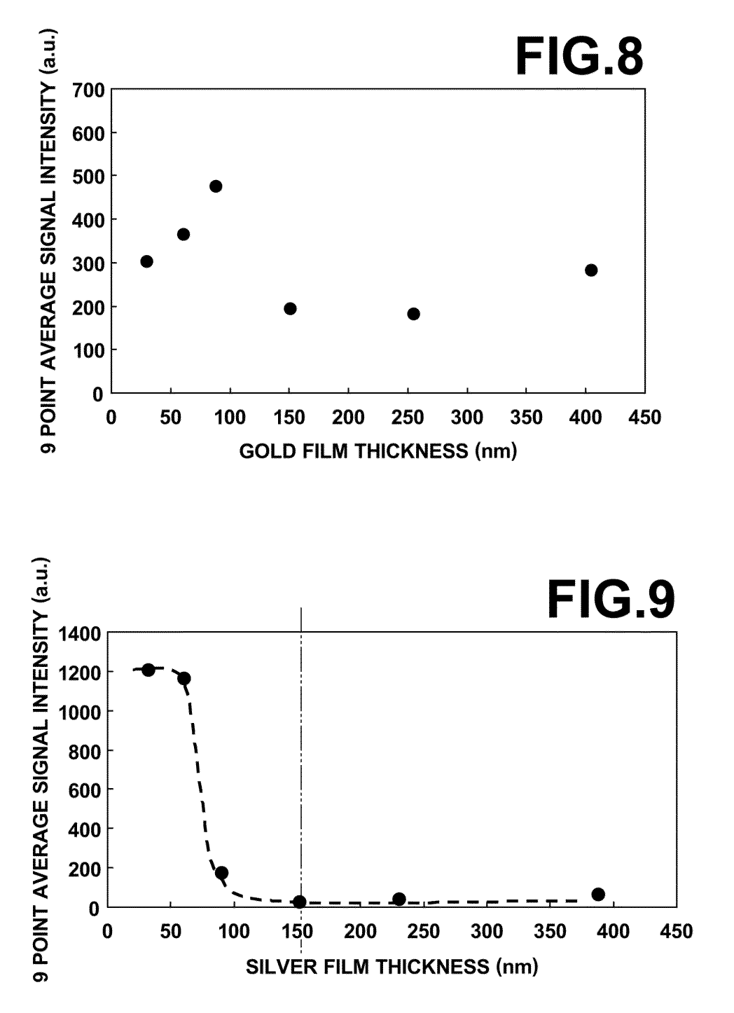

FIG. 9 is a graph that plots peak intensities of 1360 cm⁻¹ after removing white noise against Ag vapor deposited film thickness as the horizontal axis, using Raman shift spectrum distributions obtained by detecting Raman scattered light at the front surfaces of the substrates for each of the samples on which Ag was vapor deposited.

It can be understood that signal intensities decrease drastically when the film thickness becomes 150 nm or greater and that substantially no signals are obtained in the case of silver. The reason for the decrease in signal intensities is considered to be because the degree of optical electrical field enhancement deteriorates because the granule sizes increase, the granules contact each other, and become electrically continuous with each other, as in the case of gold. Further, the silver layer gradually becomes flat while the film thickness is relatively thin, then silver is further accumulated on the flattened silver layer. Therefore, it is considered that the silver layer readily becomes electrically continuous, resulting in the significant degrease in the optical electrical field intensity.

What is claimed is:

1. A method for producing an optical electrical field enhancing device, comprising:
a thin film forming step that forms a thin film formed of one of a first metal and a metal oxide on a substrate;
a structure layer of fine protrusions and recesses forming step that forms a structure layer of fine protrusions and recesses formed of one of the first metal and the metal oxide, by causing the thin film formed on the substrate to undergo a hydrothermal reaction; and
a metal layer forming step that forms a metal structure layer of fine protrusions and recesses constituted by a second metal on the surface of the structure layer of fine protrusions and recesses.

2. A method for producing an optical electrical field enhancing device as defined in claim 1, wherein:
a metal layer having a structure of protrusions and recesses having a different shape from the structure layer of fine protrusions and recesses on the surface thereof is formed as the metal structure layer of fine protrusions and recesses in the metal layer forming step.

3. A method for producing an optical electrical field enhancing device as defined in claim 1, wherein:
the second metal is one of gold, silver, copper, aluminum, and platinum.

4. A method for producing an optical electrical field enhancing device as defined in claim 2, wherein:
the second metal is one of gold, silver, copper, aluminum, and platinum.

5. A method for producing an optical electrical field enhancing device as defined in claim 1, wherein:
the metal layer forming step is a metal vapor deposition step that forms the metal layer constituted by the second metal on the surface of the structure layer of fine protrusions and recesses by vapor deposition.

6. A method for producing an optical electrical field enhancing device as defined in claim 2, wherein:
the metal layer forming step is a metal vapor deposition step that forms the metal layer constituted by the second metal on the surface of the structure layer of fine protrusions and recesses by vapor deposition.

7. A method for producing an optical electrical field enhancing device as defined in claim 5, wherein:
the second metal is gold; and
the thickness of the film formed by vapor deposition is 30 nm or greater.

8. A method for producing an optical electrical field enhancing device as defined in claim 6, wherein:
the second metal is gold; and
the thickness of the film formed by vapor deposition is 30 nm or greater.

9. A method for producing an optical electrical field enhancing device as defined in claim 5, wherein:
the second metal is silver; and
the thickness of the film formed by vapor deposition is 150 nm or less.

10. A method for producing an optical electrical field enhancing device as defined in claim 6, wherein:
the second metal is silver; and
the thickness of the film formed by vapor deposition is 150 nm or less.

11. A method for producing an optical electrical field enhancing device as defined in claim 1, further comprising:
a laminating step that laminates one of a third metal different from the second metal and a dielectric on the metal structure layer of fine protrusions and recesses formed by the second metal.

12. A method for producing an optical electrical field enhancing device as defined in claim 1, wherein:
the metal film forming step is a fine metal particle dispersing step that disperses fine metal particles formed by the second metal on the surface of the structure layer of fine protrusions and recesses.

13. A method for producing an optical electrical field enhancing device as defined in claim 12, wherein:
the diameters of the fine metal particles are 100 nm or less.

14. A method for producing an optical electrical field as defined in claim 1, wherein:
the first metal is aluminum, and the metal oxide is alumina.

15. A method for producing an optical electrical field as defined in claim 1, wherein:
the hydroxide is at least one of bayerite and boehmite.
